(19) United States
(12) Patent Application Publication
(10) Pub. No.: US 2009/0135598 A1
(43) Pub. Date: May 28, 2009

(54) ELECTRICAL LAMP SYSTEM

(75) Inventor: David Amos, South Yorkshire (GB)

Correspondence Address: KNOBBE MARTENS OLSON & BEAR LLP, 2040 MAIN STREET, FOURTEENTH FLOOR, IRVINE, CA, 92614, US

(73) Assignee: ASD LIGHTING PLC, South Yorkshire (GB)

(21) Appl. No.: 12/175,412

(22) Filed: Jul. 17, 2008

(30) Foreign Application Priority Data
Jul. 17, 2007 (GB) 0713792.0

(51) Int. Cl. F21V 21/00

(52) U.S. Cl. 362/249.01

(57) ABSTRACT

An electrical lamp system is provided that comprises a base unit and a lamp unit for attachment to the base unit. The base unit includes a housing to be fixed to a wall or ceiling and a plurality of contact terminals that are arranged to contact corresponding contact terminals of the lamp unit when attached. A plurality of connection terminals secured to the base housing are adapted for connection to wires fed to the base unit such that wires connected to the connection terminals can power the lamp unit via the base unit contact terminals. The lamp unit includes a lamp housing an electrical lamp secured to the housing, a plurality of contact terminals arranged to contact said contact terminals of the base unit. The system includes locating means arranged to locate the lamp unit in a first position against the base unit in which the lamp unit is permitted to be separated from the base unit by translation of the lamp unit in a direction away from the base unit along a separation axis. The system also includes guide means that guide rotation of the lamp unit against the base unit about said axis from said first position to a second position, the second position being a position in which said contact terminals of the base unit are in electrical contact with said contact terminals of the lamp unit. In the second position, attachment means attaches the lamp unit to the base unit by preventing separation of the lamp unit from the base unit by translation of the lamp unit along said axis.

### CROSS-REFERENCE TO RELATED APPLICATIONS

This application claims the benefit of United Kingdom Patent Application No. 0713792.0, filed Jul. 17, 2007, which is incorporated in its entirety by reference herein.

### FIELD OF THE INVENTION

The present invention relates to electrical lamp systems for fixing to walls or ceilings.

### BACKGROUND OF THE INVENTION

Electrical lamp systems, comprising a base unit and detachable lamp unit, for wall mounting are known, and typically require installation by a qualified electrician. In one known system a base unit is adapted for attachment to a wall, and wires from the wall are then fed into the base unit and connected to the appropriate connection terminals. In this known system the lamp unit is then adapted to push-fit onto the wall-mounted base unit, bringing contact terminals of the lamp unit into contact with corresponding contact terminals of the base unit. Catches on the base unit engage the lamp unit and prevent it from being separated (by pulling) from the base unit. A problem with this known arrangement is that the lamp unit is difficult to remove with ease; a plurality of tools are required to simultaneously disengage catches on either side of the system. This is particularly inconvenient, as it may become necessary to remove the lamp unit in order to change a bulb, for example. As removal is difficult, the lamp unit and/or the base unit may be damaged during the separation procedure.

Another disadvantage with known lamp systems is that when the lamp unit is removed, this may expose live terminals on the base unit. When the terminals can be touched with a bare hand, this is clearly a safety hazard, and in general such systems cannot be left live with the lamp unit removed.

### SUMMARY OF THE INVENTION

Accordingly, it is an object of embodiments of the invention to obviate or mitigate one or more of the problems associated with the prior art systems. Embodiments of the invention aim to offer improved electrical lamp systems.

According to the present invention there is provided an electrical lamp system comprising:
a base unit for fixing to a wall or ceiling; and
a lamp unit for attachment to the base unit,
the base unit comprising a base housing, fixing means arranged for fixing the base housing to a wall or ceiling, a plurality of contact terminals secured at respective positions to the base housing and arranged to contact corresponding contact terminals of the lamp unit when attached, a plurality of connection terminals secured at respective positions to the base housing and adapted for connection to respective wires fed to the base unit, and connection means connecting the base unit contact terminals to the connection terminals such that wires suitably connected to the connection terminals can power the lamp unit via the base unit contact terminals,
the lamp unit comprising a lamp housing, at least one electrical lamp secured to the housing, a plurality of contact terminals secured at respective positions to the lamp housing and arranged to contact said contact terminals of the base unit, and connection means connecting the lamp unit contact terminals to the electrical lamp,
wherein the system further comprises:
attachment means arranged to attach the lamp unit to the base unit;
locating means arranged to locate the lamp unit in a first position against the base unit when the base unit is fixed to a wall or ceiling, the first position being a position in which the attachment means permits the lamp unit to be separated from the base unit by translation of the lamp unit in a direction away from the base unit along a separation axis; and
guide means arranged to permit and guide rotation of the lamp unit against the base unit about said axis from said first position to a second position, the second position being a position in which said contact terminals of the base unit are in electrical contact with said contact terminals of the lamp unit and in which the attachment means attaches the lamp unit to the base unit by preventing separation of the lamp unit from the base unit by translation of the lamp unit along said axis.

In certain embodiments the arrangement is such that when the base unit is fixed to a flat wall or ceiling using the fixing means, the separation axis is substantially perpendicular to the flat surface of the wall or ceiling.

In certain embodiments the base housing is generally circular, centred on the separation axis.

In certain embodiments the base housing comprises a generally cylindrical wall centred on the separation axis and extending along that axis, and the locating means and the guide means comprise the cylindrical wall.

In certain embodiments the base housing further comprises a central portion, connected to and located radially inside the cylindrical wall, and the base unit contact terminals and connection terminals are secured to the central portion.

In certain embodiments the base housing further comprises an outer portion, connected to and located radially outside the cylindrical wall. In such embodiments, the outer portion may comprise the fixing means. The fixing means may, for example, comprise a first radially extending lug provided with a fixing hole to permit a screw to pass through the hole to fix the lug to a wall or ceiling, and at least one further radially extending lug provided with a respective slot to permit a screw to pass through the slot into a wall or ceiling and permit a limited rotation of the base unit about said fixing hole before the screw through the respective slot is tightened.

In certain embodiments the lamp housing comprises a generally annular portion, adapted to locate over said cylindrical wall when the lamp unit is located in said first position, and a plurality of attachment members, each attachment member extending radially from the generally annular portion, said outer portion comprising a plurality of engagement surfaces, each engagement surface being arranged to engage a respective one of the attachment members when the lamp unit is located in the first position, said outer portion further comprising a plurality of captivating slots each arranged to receive at least a portion of a respective attachment member when the lamp unit is rotated from the first to the second position so as to inhibit translation of the lamp unit along the separation axis, and said outer portion further comprising a plurality of guide surfaces each arranged to contact and guide a respective attachment member from the respective engagement surface into the respective captivating slot as the lamp unit is rotated from the first to the second position.

In certain embodiments each attachment member extends radially inwardly from the annular portion.

In certain embodiments at least a portion of each said guide surface is ramped such that as the lamp unit is rotated from the first to the second position against the base unit the lamp unit also moves along the separation axis.

Certain embodiments further comprise locking means arranged to lock the lamp unit in said second position to prevent rotation of the lamp unit from said second position. The locking means in certain examples comprises a locking member resiliently mounted on the lamp unit and locking member receiving means provided on the base unit, the arrangement being such that as the lamp unit is rotated from the first to the second position the locking member is deflected and then springs into engagement with the receiving means to prevent rotation of the lamp unit from the second to the first position.

In certain embodiments the locking means comprises a locking member resiliently attached to the annular member, and the outer portion comprises means for receiving the locking member when the lamp unit is in the second position. In certain examples this locking member is resiliently attached to one of said attachment members.

In certain embodiments the lamp unit further comprises means for disengaging the locking member from the receiving means so as to permit rotation of the lamp unit from the second to the first position. In certain examples this means for disengaging comprises means for pulling the locking member in a direction generally radially outwards. The pulling means may comprise a lever pivotally mounted to the lamp housing and a connecting member connecting the lever to the locking member.

In certain embodiments the lamp unit comprises an outer portion, attached to and located generally radially outside the annular portion, and said lever is pivotally mounted to the lamp unit outer portion.

The connecting member may comprise a toothed portion, and the locking member may comprise a slot adapted to receive and engage said toothed portion such that the connecting member can be pulled to deflect the locking member.

In certain embodiments the base unit housing comprises at least one aperture for feeding a wire through the housing for connection to at least one of the connection terminals.

In certain embodiments the base unit housing comprises at least one frangible portion removable to provide an aperture for feeding a wire through the housing for connection to at least one of the connection terminals.

In certain embodiments the base housing is adapted to prevent touching of any of the base unit contact terminals and connection terminals with bare hands. For example, the arrangement may be such that each base unit contact terminal is accessible to the respective lamp unit contact terminal through a respective access slot provided in the base housing. Each base unit connection terminal may be accessible to a wire fed into the base unit through a respective access recess provided in the base housing.

In certain embodiments each base unit contact terminal is sprung.

In certain embodiments the base unit contact terminals comprise a live contact terminal, a neutral contact terminal, and an earth contact terminal, and the connection means is arranged to connect each of the live, neutral and earth contact terminals separately to a respective one of said connection terminals.

In certain embodiments the live contact terminal is a switch live contact terminal, and the connection means connects the switch live contact terminal to a switch live connection terminal. In such embodiments, the base unit may further comprise an additional live contact terminal connected to a live connection terminal, and the lamp unit may then comprise four contact terminals, each arranged to engage a respective one of the live, switch live, neutral and earth contact terminals of the base unit. The switch live connection terminal is only live when a connected switch is the appropriate state, and can be used to provide switching of the lamp, on and off. The live connection terminal in contrast may be permanently live, and can be used to supply power continuously to the lamp unit, for example to charge a battery arranged to provide power to illuminate the lamp, or some ancillary illuminating device, in the event of a mains power supply interruption. Thus, in certain embodiments the lamp unit may comprise a battery arranged to power and hence illuminate illumination means in the event of mains supply interruption.

In certain embodiments each connection terminal comprises a respective terminal block providing at least one wire receiving aperture for receiving a stripped wire end and wire clamping means for clamping the received stripped wire end in said receiving aperture.

In certain embodiments the plurality of connection terminals comprises:
a switch live terminal block connected to the live contact terminal and providing a wire receiving aperture and clamping means;
a neutral terminal block connected to the neutral contact terminal and providing at least two said wire receiving apertures and associated clamping means;
an earth terminal block connected to the earth contact terminal and providing at least three said wire receiving apertures and associated clamping means; and
a live terminal block providing at least three said wire receiving apertures and associated clamping means,
whereby the base unit may be connected as a junction box between two three-core cables and to a three-core switch cable.

The live terminal block in certain embodiments is connected to an additional live contact terminal.

In certain embodiments each said wire receiving aperture and each corresponding clamping means is arranged in a respective recess provided in the base housing, each recess being configured to prevent touching of the respective terminal block or clamping means by a bare hand.

In certain embodiments each lamp unit contact terminal comprises a respective pin. Each pin may have a longitudinal axis generally parallel to the separation axis. Each pin may be arranged such that its longitudinal axis is radially spaced from the separation axis, such that as the lamp unit is rotated from the first to the second position each pin travels through a respective arc. The pin axes may be differently spaced from the separation axis, such that each said arc has a different respective radius.

In certain embodiments the base unit comprises a plurality of arcuate pin-receiving slots, each arranged to axially receive a respective one of said pins and to permit the received pin then to travel along its respective arc as the lamp unit is rotated to bring the pin into contact with the respective base unit contact terminal.

In certain embodiments the lamp unit comprises a plurality of guide members, each guide member being arranged adjacent a respective one of said pins, the base unit comprising a plurality of arcuate guide surfaces, each arcuate guide surface being arranged to contact a respective one of said guide members when the lamp unit is in the first position and to guide the guide member along a respective arcuate path as the lamp unit is rotated from the first position towards the second position to bring the respective pin into its respective pin-receiving slot and then into engagement with its respective base unit contact member. At least a portion of each arcuate guide surface is ramped in certain examples.

In certain embodiments each guide member extends axially at least to the end of its respective pin.

In certain embodiments the each guide member is arranged radially outside its respective pin.

In certain embodiments the base housing comprises a base portion and a cover portion attached to the base potion, said base unit contact terminals and connection terminals being secured to the base portion, and the cover portion comprising said arcuate pin-receiving slots and arcuate guide surfaces.

Other aspects of the invention provide a base unit, and a lamp unit for a system as summarised above.

### BRIEF DESCRIPTION OF THE DRAWINGS

Embodiments of the invention will now be described by way of example with reference to the accompanying drawings, of which:

FIG. 1 is a highly schematic cross section of a lamp system embodying the invention;

FIG. 2 is a plan view of the base unit of another lamp system in accordance with a second embodiment of the invention;

FIG. 3 is a perspective view of part of the base unit from FIG. 2;

FIG. 4 is a view of part of the lamp unit of the lamp system whose base unit is shown in FIGS. 2 & 3;

FIG. 5 shows the part of the lamp unit from FIG. 4 in engaged position with respect of the part of the base unit from FIG. 3;

FIG. 6 shows components of the release mechanism of the second embodiment of the invention;

FIG. 7 is a view of part of the underside of the lamp unit of the second embodiment, illustrating components of the release mechanism;

FIG. 8 is a view of part of the base unit of the second embodiment, illustrating its central portion in particular;

FIG. 9 is a view of a lamp unit connecting pin and corresponding guide member of the lamp unit of the second embodiment of the invention;

FIG. 10 is a view of one of the base unit contact terminals of the second embodiment of the invention;

FIG. 11 is a view of part of the base unit of the second embodiment, illustrating the arrangement of one of the contact terminals with respect to its corresponding access slot in the cover portion;

FIG. 12 is a view of part of one of the lamp unit contact pins attached to the lamp unit housing of the second embodiment;

FIG. 13 is a view of part of the base unit of another embodiment of the invention, with the cover portion removed from the base portion to enable the connection means between the connection terminals and contact terminals to be seen;

FIG. 14 is a view of the base unit of another embodiment of the invention;

FIG. 15 is a view of part of the lamp unit housing for engaging with the base unit of FIG. 14, along with part of the catch release mechanism;

FIG. 16 is a close up view of part of the release mechanism from FIG. 15;

FIG. 17 is another view of part of the base unit of the embodiment from FIGS. 14-16;

FIG. 18 is a view of the base unit from FIG. 14 engaged by part of the corresponding lamp unit housing and also showing part of the catch release mechanism;

FIG. 19 shows part of the base unit of FIG. 14, and in particular a housing component to which connection terminals and the contact terminals are attached;

FIG. 20 is a view of the nominal underside of the components illustrated in FIG. 19;

FIG. 21 is a view of the underside of a light fitting (or luminaire) of a lamp system embodying the invention;

FIG. 22 is a isometric view of the light fitting from FIG. 21;

FIGS. 23 & 24 are more detailed views of the components of the locking mechanism of the light fitting from FIGS. 21 & 22;

FIG. 25 is a plan view of a disposable cap for use with a base unit (which may also be referred to as a first fit unit) embodying the invention;

FIG. 26 is a cross section of a cap of FIG. 25 along line A-A;

FIG. 27 is an isometric view of a lamp system base unit embodying the invention and to which the disposable cap from FIGS. 25 & 26 is fitted;

FIG. 28 is an isometric view of the base unit from FIG. 27 with the cap removed;

FIG. 29 is a plan view of the base unit of another embodiment; and

FIG. 30 is a cross section of a clip arrangement used in another embodiment to attach the diffuser of the lamp unit to the lamp unit back portion;

FIG. 31 is an underside view of the lamp unit back portion and attached diffuser of an embodiment incorporating the clip mechanism of FIG. 30;

FIG. 32 is an isometric view of the clip from FIGS. 30 and 31; and

FIGS. 33 and 34 are isometric views of part of the embodiment of FIGS. 30-32, with the clip in the closed and open positions respectively.

FIG. 35 (a), (b) and (c) are a side, plan and perspective view of a base unit of another lamp system in accordance with a second embodiment of the invention and corresponding to the embodiment illustrated in FIG. 2.

### DETAILED DESCRIPTION OF THE PREFERRED EMBODIMENT

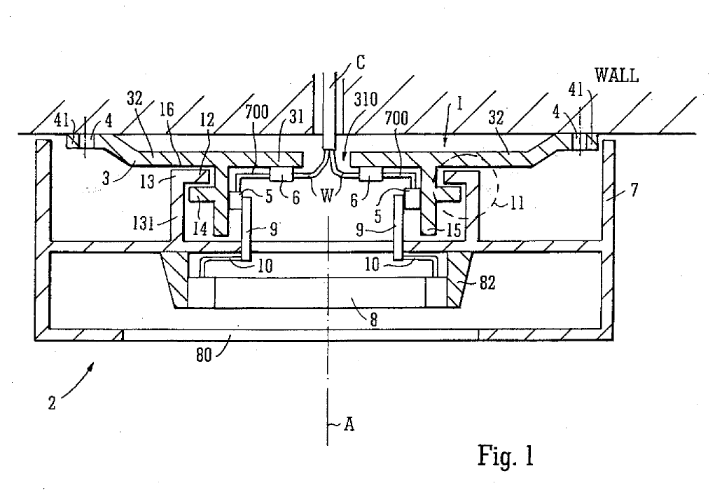

Referring now to FIG. 1, this is a highly schematic cross section of a lamp system in accordance with a first embodiment of the invention. The electrical lamp system is shown attached to a generally flat wall. The lamp system comprises a base unit 1 which comprises a base unit housing 3 which is provided with fixing means in the form of holes 4 through fixing lugs 41. The base unit housing 3 is fixed to the wall by means of suitable screws passing through the fixing holes 4 into the wall. Also shown in the figure is a nominal separation axis A which is generally perpendicular to the wall surface. A portion of the base unit housing 3 adjacent the wall is substantially flat, and then projecting forward from this in the axial direction is a generally cylindrical portion 15. This cylindrical portion is centred on the separation axis A. An inner portion 31 of the base housing is located radially inside this cylindrical wall 15, and an outer portion 32 is located radially outside the wall 15. An aperture 310 centred on the separation axis A is provided in the base housing inner portion and wires W are fed into the base unit through this hole 310. The individual wires are components of a cable C emerging from the wall. A plurality of connection terminals 6 are secured in respective positions to the base housing and the wires W fed into the housing are connected respectively to these contact terminals. The base unit also comprises contact terminals 5 secured to the housing 3 which are arranged to contact corresponding contact terminals 9 of the lamp unit. Electrically conductive connection means 700 are arranged to provide electrical connection between the connection terminals 6 and the contact terminals 5 such that when the lamp unit is correctly mounted to the base unit the lamp 8 can be powered via the cable C.

The lamp unit 2 (which may also be described as a luminaire) comprises a lamp housing 7, an electrical lamp 8 secured to the housing (by securing means 82). The lamp unit also comprises a plurality of contact terminals 9 secured a respective position to the lamp housing and arranged to contact the contact terminals 5 of the base unit. Connection means 10 are also provided in the lamp unit, electrically connecting the contact terminals 9 to the lamp 8. The system further comprises attachment means 11 arranged to attach the lamp unit to the base unit. In this first example, the attachment means 11 comprises a plurality of attachment members 12 extending radially inwardly from a generally annular portion 13 of the lamp unit housing, and a corresponding plurality of engaging members 14 provided on the base unit housing. In this example these engaging members 14 extend radially outward from the base unit cylindrical portion 15. It will be appreciated that these engagement members 14 together with the surface of the base unit housing 16 that the base of the cylindrical portion 15 define respective receiving slots in which the attachment members 12 are engaged. FIG. 1 shows the lamp unit in a nominal second position with respect to the base unit in which the attachment members 12 are captivated by the members 14 (i.e. captivated in their respective slots) such that the lamp unit cannot be separated from the base unit by simply translating it away from the wall along the separation axis A. In other words, the attachment means 11 prevents axial separation of the base unit and lamp unit from the second position. Although this cannot be seen from FIG. 1, the captivating members 14 do not extend fully around the circumference of the cylindrical portion 15. Thus, in order to attach the lamp unit to the base unit the lamp unit is first located on the base unit in a first position in which the attachment members 12 are not captured in their respective slots and so the lamp unit can still be separated from the base unit along the separation axis A. The lamp unit is then rotated about the separation axis A to bring the attachment members 12 into engagement with their respective receiving slots. The lamp system comprises locating means arranged to locate the lamp unit in this first position against the base unit. In this first example, the locating means includes the generally cylindrical wall or cylindrical portion 15 of the base unit housing together with the generally annular portion 13 of the lamp unit housing and the connection members 12 extending radially inward from it. As the lamp unit is brought into engagement with the base unit the annular portion 13 and attachment members 12 locate over the cylindrical wall 15 to enable the lamp unit to placed in the first position. The lamp system further comprises guide means arranged to permit and guide rotation of the lamp unit against the base unit about the axis A from the first position to the second position (i.e. the position illustrated in FIG. 1) to bring the contact terminals 9 of the lamp unit into engagement with the contact terminals 5 of the base unit. In this first example the guide means includes a surface 16 of the outer portion of the base unit housing and the base surface of the cylindrical wall 15.

In the embodiment of FIG. 1 the lamp unit also comprises a transparent window 80 to allow radiation omitted from the lamp 8 to emerge. This window 80 may be a diffuser, lens, or semi-transparent component. It may in certain embodiments be an integral part of the housing 7.

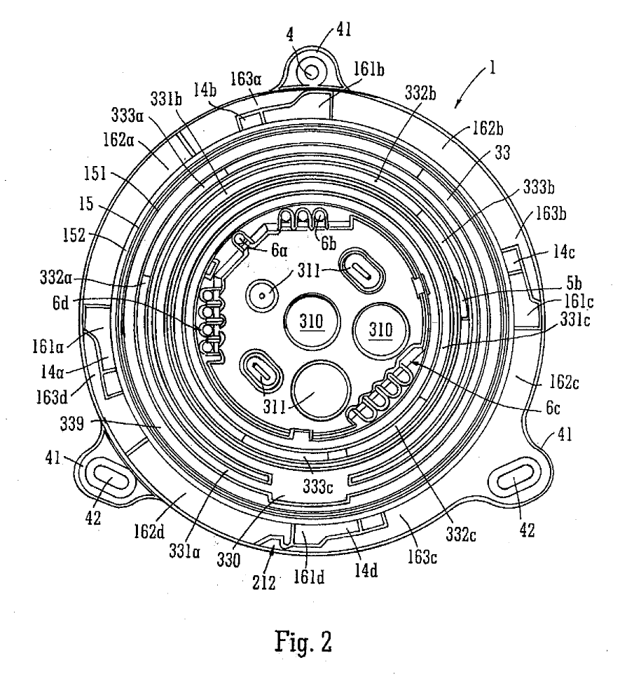

Moving onto FIGS. 2-12, these illustrate various components of an electrical lamp system in accordance with a second embodiment of the invention. Referring firstly to FIG. 2, this is a nominal plan view of the base unit 1 of the second embodiment. In plan view, the base unit housing is generally circular and comprises a cylindrical wall 15 (which may also be referred to as a cylindrical portion). The contact terminals 5 and connection terminals 6 are attached to an inner portion 31 of the base housing, radially inside the cylindrical wall 15. The base unit housing also comprises a generally circular cover portion 33 which is attached to the inner portion by means of suitable clips. This cover portion covers the connection means between the contact terminals and the connection terminals, and inhibits access to the contact terminals and parts of the connection terminals. In this embodiment the cover portion 33 is formed from transparent material and provides a window 330 for viewing a level indicator mounted on the inner portion of the housing. Although not shown in this figure, that level indicator in certain embodiments takes the form of a spirit level which can thus be used to attach the base unit in a defined orientation with respect to a vertical wall. The outer portion of the base housing is located radially outside the cylindrical wall 15 and includes fixing means in the form of a plurality of radially extending fixing lugs through which suitable fixing apertures are provided. These fixing lugs 41 include one lug providing a circular fixing hole 4 and two lugs 41 each providing fixing slots 42. Thus, to fix the base unit to the wall a screw can first be passed through fixing hole 4 and prissily tightened to the wall. The screws may also be placed through fixing slots 42 and partially tightened. However, the slots 42 are arranged such that rotation of the unit about the screw through hole 4 is permitted over a limited range so that the unit can be correctly aligned to the vertical (using the level indicator visible through window 330) all screws may then be tightened to firmly fix the base unit to the wall.

The inner portion of the base unit housing comprises a plurality of apertures 310 through which wires or cables maybe fed from a wall or ceiling against which the unit is attached into the base unit. One of these apertures 310 is centrally located, i.e. it is centred on the separation axis. The inner portion of the base housing also comprises a plurality of frangible portions 311 which can easily be removed to provide further apertures for passing wires from the rear of the base unit through into it.

The outer portion of the base housing comprises parts of the attachment means for attaching the lamp unit to the base unit, parts of the locating means for locating the lamp unit in a first position against the base unit, and part of the guide means arranged to permit and guide rotation of the lamp unit against the base unit from the first position to the second position. The outer portion of the base unit provides part of the attachment means as follows. Generally, the outer portion is in the form of a circumferential flange extending generally radially outwards from the cylindrical wall 15. However, rather than simply being flat, this flange comprises 4 for engagement or entrapment members 14 a, b, c and d each of these members 14 extends in a generally circumferential direction and is axially spaced from an adjacent surface 163 of the outer portion to define a respective receiving slot 140. Each receiving slot 140 has an open end directed in the tangential direction so that it is not accessible by merely translating the lamp unit with respect to the base unit along the separation axis. Instead, and attachment member 12 of the lamp unit to be received in the slot it must be slid in from the side by suitable rotation of the lamp unit about the separation axis A. The outer portion of the base housing provides part of the guide means and locating means as follows. A nominal upper surface 161 of each captivating member 14 is generally flat (in the sense that it lies in a plain perpendiculitively separation axis A) as the lamp unit is brought into engagement with the base unit the annular portion of the lamp unit fits over the cylindrical wall 15 of the base unit and the attachment members of the lamp unit come into engagement with (i.e. rest against) the four flat surface portions 161 a, b, c and d of the captivating members 14a. This is the nominal first position. The outer portion of the base housing is then provided with sloping or ramp portions 162, each of which connects the respective flat portion 161 to the second respective flat portion 163. Thus, as the lamp unit is located against the base unit in the first position and then rotated clockwise, the attachment members 12 of the lamp unit which were in contact with flat portions 161 progressively moved down the ramp portions 162 and then engage flat portions 163, which then guide the attachment members 12 as the lamp unit is rotated yet further so that the attachment members 12 are received in the respective slots 140 underneath the engagement members 14d. The closed end of each slot 140 thus defines a limit to rotation of the lamp unit and so defines the second position of the lamp unit with respect to the base unit. The base unit also comprises a locking member receiving means in the form of a slot 212 extending generally radially into the outer portion for receiving a locking member provided on the lamp unit to lock the lamp unit in the second position (i.e. preventing rotation from the second position back to the first position).

The central portion of the base unit also comprises part of the locating means and guiding means as follows. The cover portion 33 provides a plurality (3 in this example) of generally annular or arcuate tracks, separated by circular, upstanding walls these tracks are concentric, but are spaced at different radii from the nominal centre of the unit. Each track comprises a respective flat portion 331 against which a corresponding guide member from the lamp unit locates when the lamp unit is placed in the first position. Each track also comprises a respective sloping or ramped portion 332 for guiding the respective guide member axially down as the lamp unit is rotated clockwise in this example into a respective arcuate or curved slot 333. As will be appreciated from FIG. 9, a respective contact pin is arranged next to each guide member and so as the guide member is guided down into its respective slot 33a so is the contact pin. Further rotation of the lamp unit fully to the second position results in each contact pin being brought into electrical engagement with the respective contact member 5 housed in the slot.

Thus, in this second embodiment to attach the lamp unit to the base unit the lamp unit is first placed and located on the base unit in the first position. Which is then rotated clockwise until it locks into position. The lamp unit comprises a plurality of attachment members 12, each of which extends generally radially inwardly from an annular portion of the lamp unit housing. These attachment members 12 may also be described as attachment fins or locking fins. From the initial engagement surfaces 161 of the base unit defining the first position, slopped ramps 162 then guide the locking fins into position as the lamp unit is rotated. In the nominal second position the plurality of entrapment members 14 in (which may also be described as fins) hold the lamp unit in place by preventing it from it been axially separated from the base unit. The lamp unit attachment fins 12 are arranged so as to be a tight fit within the corresponding receiving slots 140 defined in the base unit so that when the lamp unit is in the second position there is substantially no axial movement permitted. The cover portion of the central portion of the base unit comprises three separate locating ramps 332 a, b and c which are portions of different annular rails or guide tracks. With provision of these guide tracks in the central portion further prevents the lamp unit from locating in the wrong position on the base unit. Nominal first contact surfaces 339 and 152 of the cover portion of the base unit and of the cylindrical wall respectively are provide you with a large chamfer to facilitate locating of the lamp unit in the first position. This effectively increases the size of the possible locating position. The edge 151 of the cylindrical wall 15 is arranged so as to be higher than the other locating areas, as it represents the first point of contact between the lamp unit and the base unit. This helps to prevent any other parts from interfering as the lamp unit is brought into engagement with the base unit.

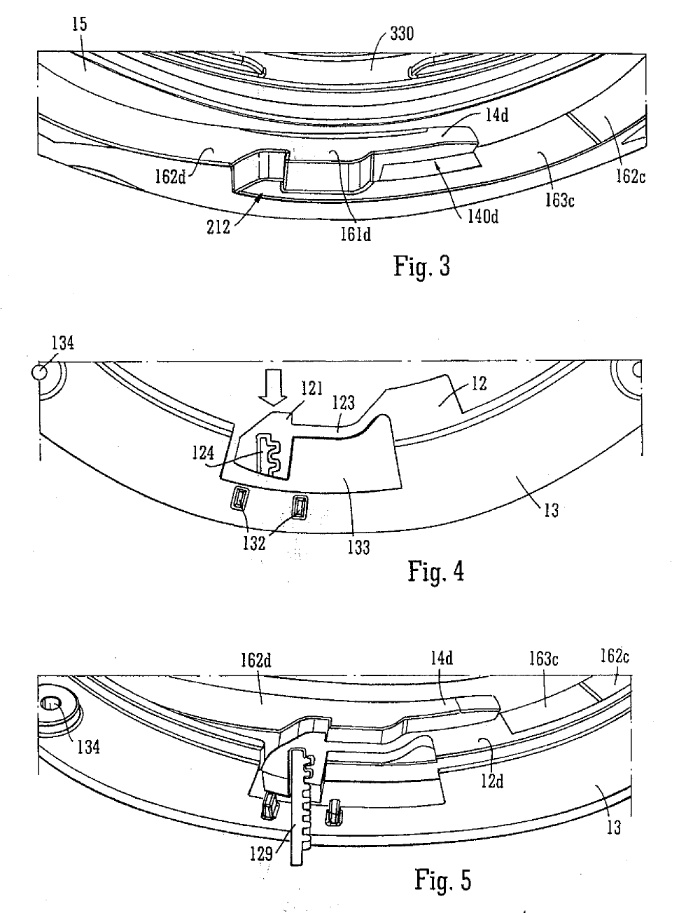

Referring now in particular to FIGS. 3, 4 and 5 these show in more detail features of the attachment, location, and guide means of the second embodiment of the invention. In FIG. 3 part of the base unit is shown comprising the outer wall of the cylindrical portion 15 and the outer, generally flange-like portion. One of the captivating members or fins 14d is shown, with the captivating slot 140d defined between it and the axially spaced flat surface 163c. The ramp surface 162c for guiding the lamp unit attachment member down into the slot 140d can also be seen. In FIG. 4, part of the lamp unit housing is shown. This is part of an annular member 13, which is attachable to the rest of the lamp unit housing by means of suitable fixing holes 134. There are four attachment members in the form of fins extending radially inwardly from this annular portion 13 (although for simplicity only one is shown in FIG. 4). This part of the lamp unit also comprises part of the locking means for locking the lamp unit in the second position. This part of the locking means comprises a locking member 121 (which may also be described as a locking catch or hook) resiliently mounted to the lamp unit annular portion 13. In fact, in this example this resilient mounting is achieved by means of a flexible supporting arm 123 connecting the locking member 121 to one of the attachment fins 12. A recess 133 is provided in the annular portion 13 to enable the locking member 121 to be deflected or pulled radially outward by the formation of its support arm 123. The stop members 132 (which may also be described as ribs or protrusions) are provided on the annular portion 13 to restrict the radially outward movement of the locking member 121. The locking member 121 also comprises a receiving slot 124 for receiving the toothed end portion 129 of a connection member 128 arranged to connect the locking member 121 to a release lever 126.

FIG. 5 shows the annular portion 13, attachment fin 12d and locking member 121 in a position with respect to the base unit that corresponds to the position when the lamp unit is in the second position (i.e. with the contact terminals of the base unit and lamp unit in contact with each other). As will be appreciated from FIGS. 3, 4 and 5, as the annular portion 13 has been rotated clockwise with respect to the base unit about the separation axis the attachment fin 12d has been guided into the slot 140d, underneath the attachment fin 14d, and the locking member 121 has been deformed and pushed radially outwards until the annular portion 13 has reached the second position in which the locking member 121 is able to spring back into the locking member receiving slot 212 on the base unit, bringing a shoulder surface of the locking member 121 into engagement with the corresponding shoulder surface of the receiving slot 212. The base unit and annular portion 13 are locked together; further rotation about separation axis is prevented by means of the engagement of the locking member in its slot 212 and by the closed end of slot 140d, and axial separation is prevented by engagement of the attachment fin 12 in the receiving slot 140. To enable the lamp unit to be released, the locking member 121 must be pulled radially outward so that it disengages from its receiving slot 212. The lamp unit can then be rotated in the anti-clockwise direction in this example about the separation axis to bring it to the first position in which axial separation is then permitted.

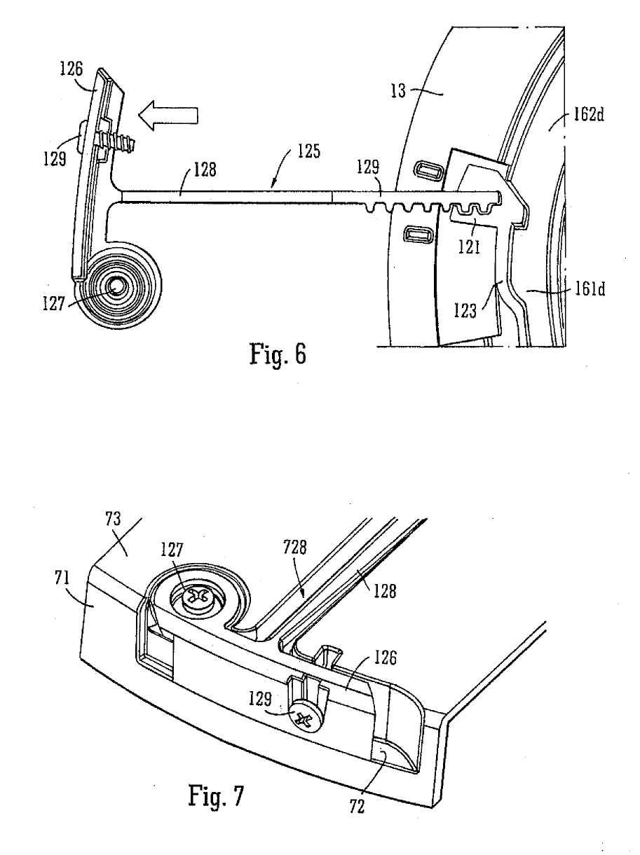

Referring now to FIGS. 6 and 7 these show further details of the release mechanism. The release mechanism includes a lever 126 pivotally attached to the lamp unit housing by means of a suitable screw 127. A connecting member 125 connects the release lever 126 to the locking member 121. This connecting member comprises a flexible portion 128 and a toothed end portion 129 (which may also be flexible) and this toothed end portion is received in the correspondingly shaped slot 124 in the locking member 121. In use the release lever 126 and annular portion 13 are both connected to the rest of the lamp unit housing and so are in defined position with respect to each other. Then, deflection of the lever 126 so that it rotates about screw 127 in the direction shown in the arrow by FIG. 6 results in pulling of the locking member radially outward to disengage it from its slot 212. In FIG. 7 the attachment of the release lever to the lamp unit housing can be seen. The lamp unit housing comprises a generally outer portion 71 which in this example is a generally cylindrical wall extending axially from a substantially flat based portion 73. The screw 127 attaches the lever to this flat portion 73 and the lever 126 is housed in a corresponding recess in the outer cylindrical wall 71. The connecting member 128 is housed within a slot 728 provided in the surface 73 of the housing. A securing screw 129 is also provided, and passes through the lever 126 to secure it to the housing cylindrical wall 71. Thus, the securing screw 129 must be removed before the lever can be actuated to release the locking member 121.

Thus, it will be appreciated from the above description of FIGS. 3-7 that when the lamp unit is located in the first position against the base unit and rotated about the separation axis it automatically locks into the second position when twisted clockwise. In order to unlock the lamp unit from the base unit it is necessary to pull the release lever 126 and then twist the lamp unit anti-clockwise. The general structure providing the engagement members 14, the flat locating surfaces 161, and the initial parts of the ramp surfaces 162 can be describes generally as a locking fin structure, and one of these locking fins has a hook-shaped hole 212 (the means for receiving the locking member). The locking member 121 provided on the lamp unit may, in certain embodiments is described as a sprung hook that fits in the hook shaped hole. This automatically locks into position when the lamp unit is rotated clockwise to the second position. The slot 124 in the locking member 121 may also be described as groove that enables the connecting member component to be fixed to the locking member 121. The ribs 132 on the lamp unit housing prevent the sprung locking member 121 or hook from been pulled to far back, thereby preventing breaking of the resilient mounting arm 123. The arrangement shown in FIGS. 4, 5 and 6 where the slot 124 in the attachment member 121 engages a toothed end of the connecting member provides the advantage that the lever 126 and connecting member 125 can be produced as an integral unit with the toothed portion 129 having relatively long length. This toothed portion 129 can then simply be cut to size, such that the integral lever and connecting member unit can be used in a plurality of lamp units where the radial distance between the locking member 121 and the outer wall 71 of the lamp unit housing may differ. The additional screw 129 securing the lever to the housing can be regarded as an anti-tamper device, preventing removal of the lamp unit from the base unit by a person without the appropriate tool.

Referring again to FIGS. 6 and 7, it will be appreciated that in certain embodiments the lever 126 is mounted on the outside of the lamp unit and it may be the only accessible part to the mechanism when the lamp system is in position (i.e. with the base unit attached to the wall or ceiling and the lamp unit attached to the base unit). The screw 129 can be regarded as a security screw which can be added to make the lamp system more vandal resistant. The flexible portion 128 of the connection member 125 should be thin enough to bend without breaking, and strong enough while intention not to break when the locking member 121 is pulled via it. The lever 126 may be arranged to pivot on a plastic boss, and is held in place with a self tapping screw 127 and a washer in certain embodiments. Looking at FIG. 7, the surface 73 of the lamp unit is a surface that will be closely adjacent a wall or ceiling surface when the lamp system is installed and so the screw 127 is inaccessible when the lamp system is in position, making the release lever 126 and associated mechanism tamper-resistant. The lamp unit in certain examples also comprised a finger hole 72 or recess to facilitate pulling of the lever 126 when the security screw 129 has been removed.

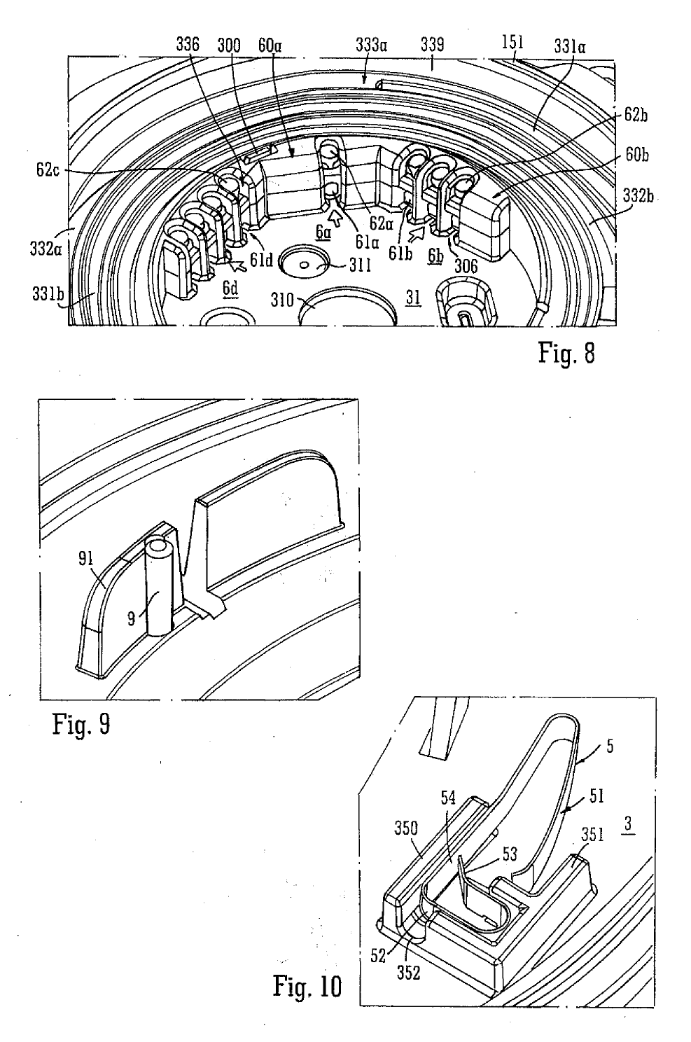

Referring now to FIG. 8, this shows in more detail some of the central portion of the base unit of the second embodiment of the invention. The plurality of connection terminals 6 are secured to a base portion of the housing and the base cover 33 is clipped over the terminals by means of clips 300. In this example each connection terminal comprises a respective terminal block providing at least one connection aperture 61 for insertion of the stripped end of a wire, and corresponding wire clamping means 62, which in this embodiment is in the form of a threaded screw received in a corresponding threaded hole in the block above the wire receiving hole 61. The base portion is arranged such that each wire-receiving hole 61 is located in a respective recess in the base portion 306. The cover portion 33 is also arranged such that when clipped in place each wire clamping screw 62 is also located inside a corresponding recess 336 provided by the cover. As will be appreciated from the proceeding description the contact terminals of the base unit are also located within their respected access slots 333. These access slots and the recesses 336 and 306 provided in the base unit housing are arranged so that no part of the connection terminals, the wire clamping means 62 or contact terminals 5 maybe touched by bare hands. This provides the advantage that the base unit maybe attached to a wall and allegedly connected to a wire or wires fed into the base unit and left as a first fit unit by an electrician. As none of the potentially live terminals are accessible to bare hands the unit is then safe, and subsequent fitting of the lamp unit to the base unit can be performed by a non-electrician.

Referring to FIG. 8 and FIG. 2, in the second embodiment the connection means connecting the contact terminals to the connection terminals are also located beneath the cover portion 33 and are also in accessible when the cover unit is in place. The connection terminals comprise a switch live terminal block connected to the live contact terminal of the base unit and providing a wire receiving aperture 61a and associated clamping means 62a. This switch live terminal block comprises an additional aperture and a clamping means which is used before the cover is fitted to connect the connecting means to the live contact terminal, and the location of this aperture and clamping means is indicated generally in FIG. 8 by 60a. As can be seen from the figure, the base portion and cover portion cover this part of the switch live terminal block when the cover is clipped in place so that it is not accessible through an electrician wiring up the base unit. Only the wiring receiving apertures and clamping means that the electrician will need to use are exposed by the base unit housing. The connection terminals also comprise a neutral terminal block connected to a neutral contact terminal of the base unit by means of wire receiving aperture and clamping means at position indicated generally by 60b (and covered by the base portion and cover portion) and the neutral terminal block also provides three wire receiving apertures 61b each accessible only through a respective recess 306 and each provided with a clamping screw 62b. Referring to FIG. 2, it can be seen at the base unit also comprises an earth terminal block 6c connected to the earth contact terminal of the base unit by means of an aperture and clamping means covered by the cover portion, and providing for wire receiving apertures and associated clamping means, each located in a corresponding recess. Lastly, the contact terminals comprise a live terminal block providing for wire receiving apertures 61d with corresponding clamping means 62c, again each recessed in the base unit housing. This live terminal block is not connected directly to any of the contact terminals of the base unit. This arrangement of shielded contact terminals is advantageous as it enables the base unit to be used as a junction box between as many as three-core cables whilst at the same time enabling three-core cable to be used to attach the base unit to a remote switch.

Thus, the lamp system base unit can be used as a junction box. All of the relevant terminals are easily accessible for an electrician, and other terminals and wiring are hidden to avoid confusion. All of the necessary electrical cables can be pulled through the holes 310 in the back of the fitting, or through additional holes followed by removal of frangible portions 311. All of the terminals can not be touched with bare hands, making the base unit a safe unit to be left connected live.

Referring now to FIG. 9, this shows one of the three contact members and its associated guide means 91 provided on the nominal rear of the lamp unit of the first embodiment. In this example, the contact member is a pin whose longitude and axis extends rearwardly from the lamp unit generally parallel to the separation axis A. The guide member 91 is positioned radially outside the pin 9 and can also be described as a fin. This fin protects the pin connector, preventing it from being damaged. The guide fin 91 is shaped so that it can be received within one of the respective guide tracks 331 on the base unit and then can then slide along that track as the lamp unit is rotated, following the perspective ramp surface 332 down into the terminal access slot 333 and then bringing the pin 9 into engagement with the respective sprung terminal 5. In other words, when the lamp unit is rotated to the second position the pin 9 is pushed against the sprung terminal making an electrical connection. Referring to FIG. 10, this shows one of the sprung base unit contact terminals in more detail. This contact 5 is formed from resilient metallic material and is shaped to be engaged within a receiving structure 350 provided on the base housing. A pin engaging portion 51 of the contact 5 is deflated as the respective pin 9 and its guide means 91 are rotated into the second position, with pin 9 resting against the conductive surface of the portion 51. The pin and guide means are then located between the portion 51 and the opposite wall portion 351 of the terminal securing feature 350. To connect the terminal 5 to the connection means and then to the respective one of the contact terminals, the contact securing structure 350 also comprises a recess 352 through which the stripped end of a connecting wire can be inserted through an aperture 52 in the contact to then be engaged between a side surface 54 of the contact material and an opposing additional resilient (i.e. deformable) portion 53. Thus, in construction or assembly of the lamp unit the contact terminal 5 can simply be inserted into its receiving structure, held there by virtue of its resilience, and then connection to the contact terminal can be quickly made by inserting a stripped end of a wore through aperture 52 to be gripped by the resilient portion of 53.

Referring now to FIG. 11, this shows in more detail one of the sprung contact terminals located beneath the cover portion of the base unit and accessible via its respective access slot 333b. This slot 333b is dimensioned so that a finger of a bare hand cannot be inserted to touch the pin engaging portion of 51b of the terminal.

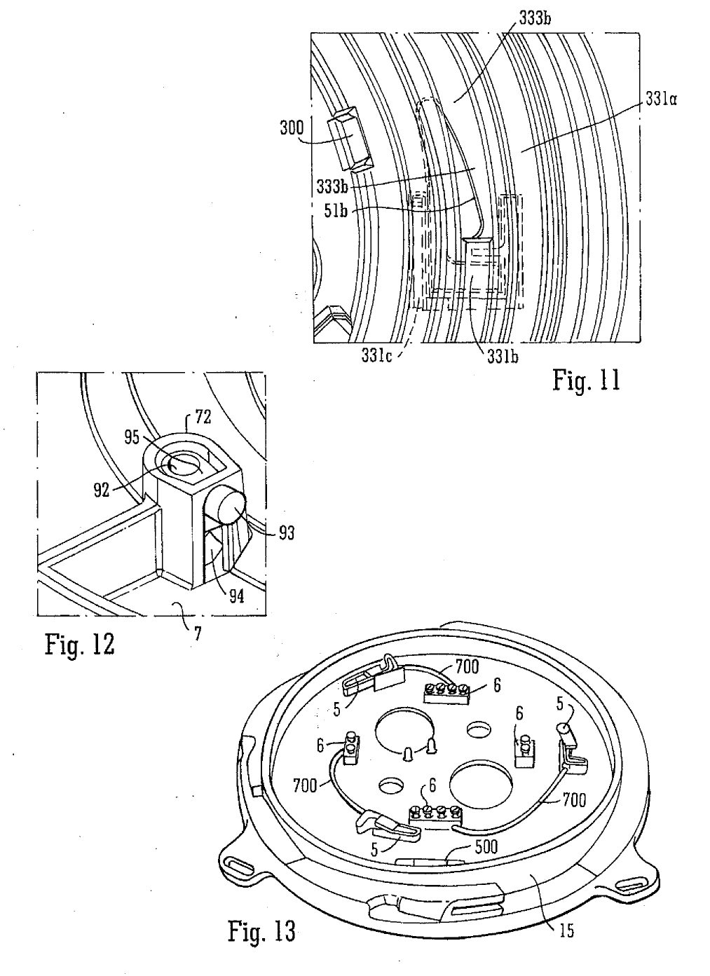

Referring now to FIG. 12, this shows the attachment of one of the contact pins 9 in the lamp housing 7. A connector block 95 is received then a corresponding securing structure 72 is provided on the lamp unit housing and a bore 92 through the connector 95 is adapted to receive the pin 9 together with a wire for connecting the pin to the lamp. The wire can be inserted up through the bore 92 together with the pin by means of access slot 94. A single screw 93 is then used to then clamp the wire and pin in place inside the bore 92.

Referring now to FIG. 13, this shows the base unit of another embodiment of the invention, similar to the second embodiment. This base unit is shown without the cover portion in place. As can be seen, there are three contact terminals 5 each connected by a respective connection means in the form of a wire 700 to a respective terminal block 6. One additional terminal block 6 is provided that is connected directly to any of the connection terminals. Mounted on the base unit housing there is also provided a spirit-level 500 to provide level indication.

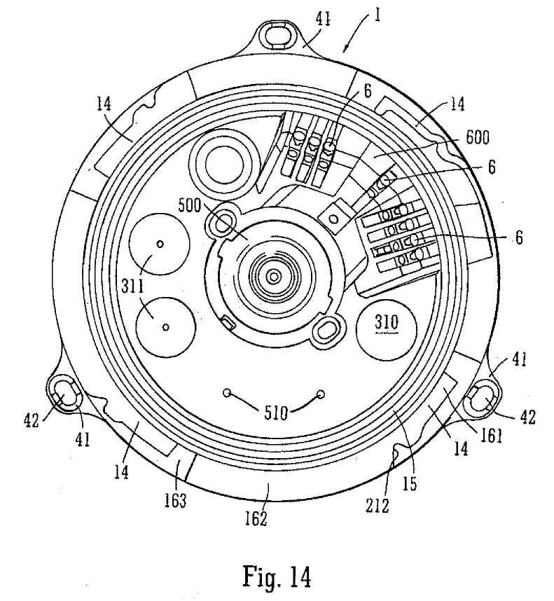

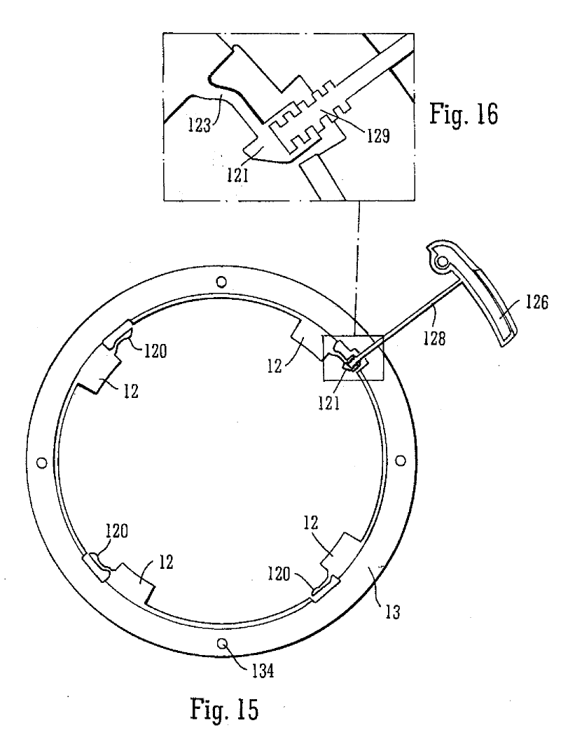

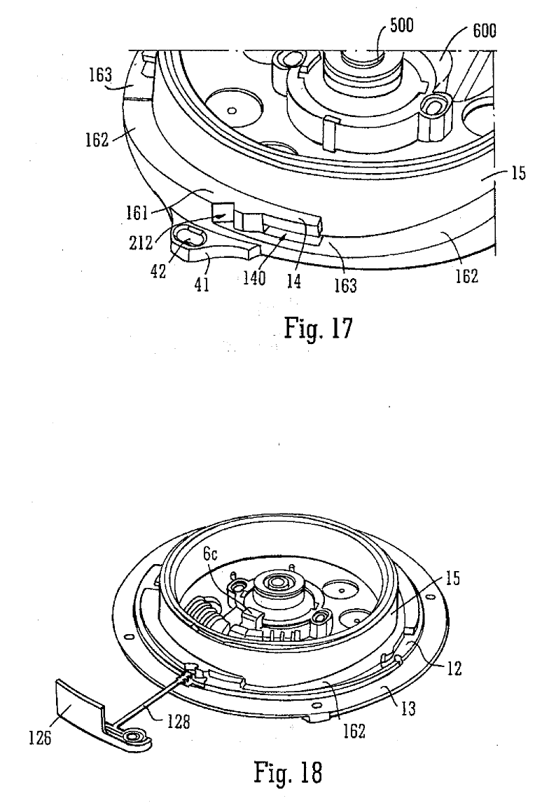

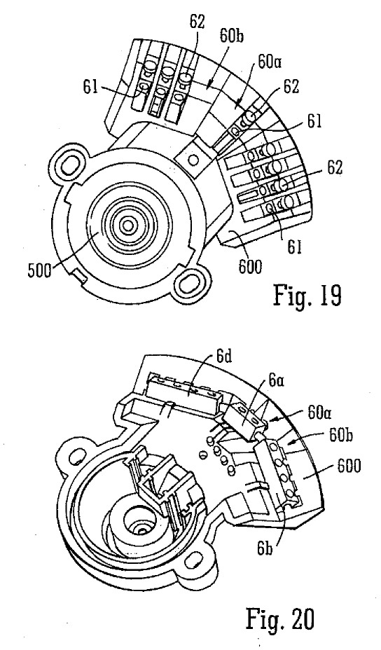

Referring now to FIGS. 14-20, these show components of another lamp system embodying the invention. Features corresponding to those of the previously described embodiments are given the same reference numerals and in general are not described again, the previous descriptions applying. Differences from the previous embodiments include the following. Referring to FIG. 14, rather than the contact terminals of the base units being sprung terminals located at different radii and different positions on the base unit, in this example there is a central contact terminal structure 500 for the type that may be found in the base unit of the electrical kettles. This contact terminal unit 500 a central aperture for receiving a pin contact on the lamp unit, an annular recess concentric with the central recess for receiving an annular generally cylindrical contact on the lamp unit, and then sprung out of contact for engaging with another generally annular outer contact or electrode on the lamp unit. Thus, as the lamp unit is located on the base unit electrical connection is made between the contacts of the lamp unit and base unit at all respective angular positions between the two, whereas in the second embodiment electrical connection was only made when the lamp unit was rotated from the first position to the second position. In the embodiment of FIG. 14, there are again a plurality of connection terminal 6 in the form of terminal blocks, and these are housed inside a terminal housing structure 600, to which the contact terminal housing structure 500 is also connected. Mounting post 510 is provided for attachment of a level indicator. Looking at FIG. 15, this shows the annular portion 13 of the lamp unit. Again it comprises four attachment fins projecting radially inwardly from the annular portion 13. To one of these fins 12 there is attached a locking member 121 adapted to engage in a corresponding slot on the base unit so that it can only be disengaged by pulling via connected member 128 and lever 126. However, each of the remaining attachment fins 12 is provided with a respective detent member 120 mounted on a respective resilient arm. Referring back to FIG. 14, each of the attachment fins 14 is provided with a recess 212 into which the locking member 121 is able to lock. The detent members 120 are able to engage to a degree with each slot 212 but do not provide any locking function, that is when the locking member 121 is pulled radially outward, the detent members 120 can be disengaged from the respective slots 212 by simply rotating the lamp unit about the axis A relative to the base unit. Thus, the lamp unit in this embodiment can lock in one of four positions to the base unit, whereas in the second embodiment there was only one locking position.

Referring now to FIG. 18, this shows the additional connecting block 6d to which a plurality of wires can be attached. Thus, this embodiment base unit can be used as a junction box.

Referring to FIG. 20, this shows how three of the terminal blocks are attached to underside of the structure 600. The contact terminals within the structure 500 and the connection means connecting the contact terminals to the terminal blocks are, however, not shown in this figure.

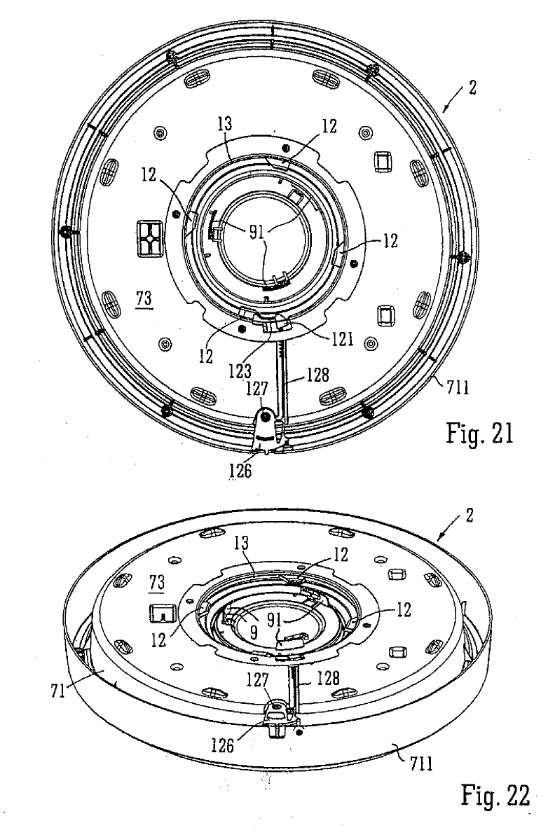

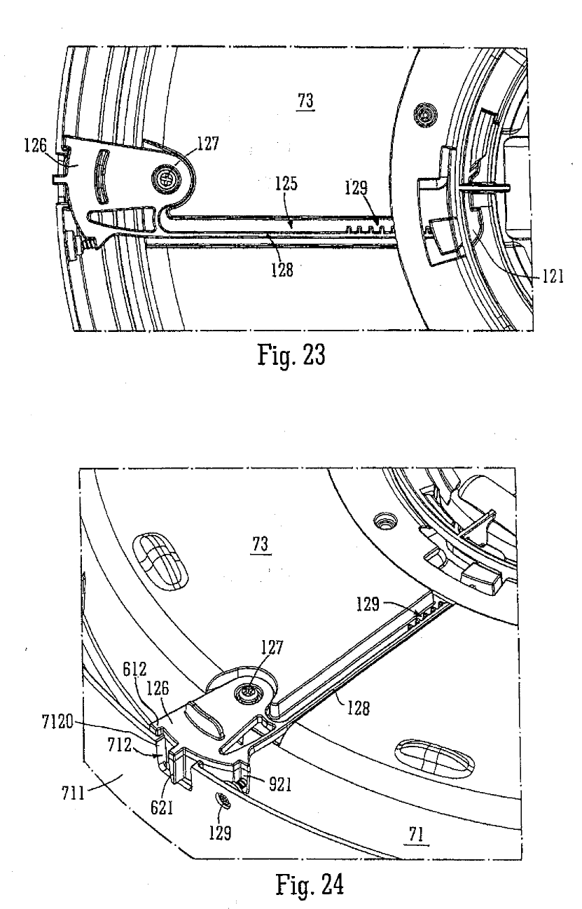

Referring now to FIGS. 21-24, these show a lamp unit or luminaire which forms part of a lamp system embodying the invention and which is adapted for attachment and electrical connection to a base unit of a type shown in FIG. 2. The luminaire comprises features in common with the lamp unit whose details are shown in FIGS. 4, 5, 6, 7, 9 and 12, and those common features are given the same reference numerals and will not be described again in detail (the above description of the corresponding features applying equally to the embodiment of FIGS. 21-24). Differences, however, are as follows. In the luminaire of FIGS. 21-24 the lever 126 for actuating the locking release mechanism is arranged to extend generally radially outward from its pivot connection (by means of screw 127) to the lamp unit housing. Thus, this lever 126 extends radially outward from the substantially flat portion 73, from the generally cylindrical inner wall 71 to another generally cylindrical outermost wall 711 which forms the outer perimeter of the luminaire. The radially outermost end of the lever 126 is provided with a tab 621 which is located inside an aperture or notch 712 in the outer wall 711 of the lamp unit housing. The locking screw 129 passes radially inwards through a threaded hole in the outer wall 711 of the luminaire and engages against a corresponding flat 921 on the locking lever 126. With the screw 129 in this position, rotation of the lever 126 about screw 127 is prevented by the screw 129 and flat 921 in one direction, and in the other direction by the abutment of the formation or shoulder 612 on the lever 126 against a corresponding shoulder or engagement surface provided on the interior on the outer wall 711. However, when the locking screw 129 is screwed out (i.e. disengaged from the flat 921) a limited rotation of the lever 126 is permitted by manipulation of the tab 621. This lever rotation results in pulling of the integral attachment member 125, which in turn pulls the catch 121 radially outward to disengage from the receiving aperture or lock hole in the base unit.

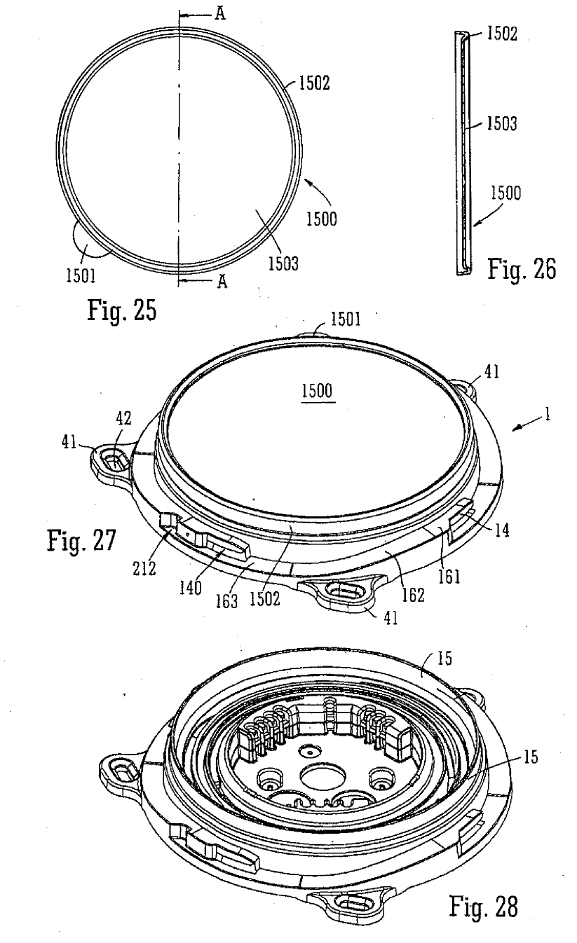

Referring now to FIGS. 25-28, in further embodiments of the invention a cap 1500 is provided which fits over the top of the cylindrical wall 15 of the base unit (or first fit unit). The cap 1500 is made from resilient material, having a generally planar flat disc portion 1503, surrounded by an annular rim 1502. Extending radially from the rim 1502 is a removal tab 1501. In FIG. 27 the cap is shown fitted to the base unit. It will be appreciated that this provides the advantage that after fitting the base unit to a wall or ceiling surface and the appropriate connections are made between the wiring and the connection terminals in the base unit, the cap can be fitted as shown in FIG. 27 to prevent the ingress of dust and/or moisture. Then, when one is ready to fit the luminaire, the cap simply has to be removed (this being facilitated by the removal tab 1501) and the luminaire located and rotated in place to lock onto the base unit and make contact with the appropriate terminals.

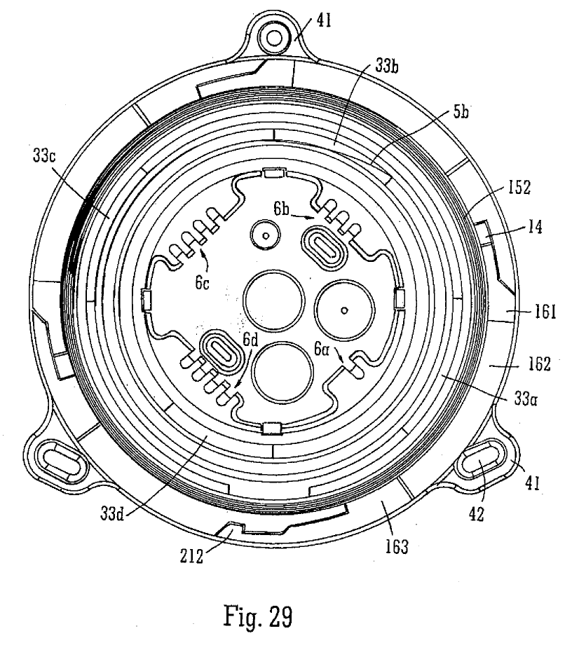

Referring now to FIG. 29, this shows the base unit of another embodiment of the invention, similar in construction to that shown in FIG. 2, but having four contact terminals 5a-5d, rather than three, each located in a respective slot 33 for receiving a respective connecting pin on the lamp unit. There are still three annular guide rings, but the outer ring contains two slots, 33a and 33c. The four contact terminals are a live contact terminal (not shown) in slot 33d, connected to a live connector block 6d, a switch live contact terminal (not shown) in slot 33a connected to a switch live connector block 6a, a neutral contact terminal 5b in slot 33b connected to a neutral connector block 6b, and an earth contact terminal (not shown) in slot 33c connected to earth connector block 6c. The switch live contact enabled a switched supply to be provided to an attached lamp unit, and is therefore used for switching the lamp on and off. The additional provision of the live contact terminal means that a permanent, or continuous supply can be provided to the lamp unit. For example, in certain embodiments the lamp unit includes a battery for powering the lamp or some other ancillary illumination device in the event of a mains power supply interruption. The live contact terminal can thus be used to provide charging of the battery, irrespective of the switch live state.

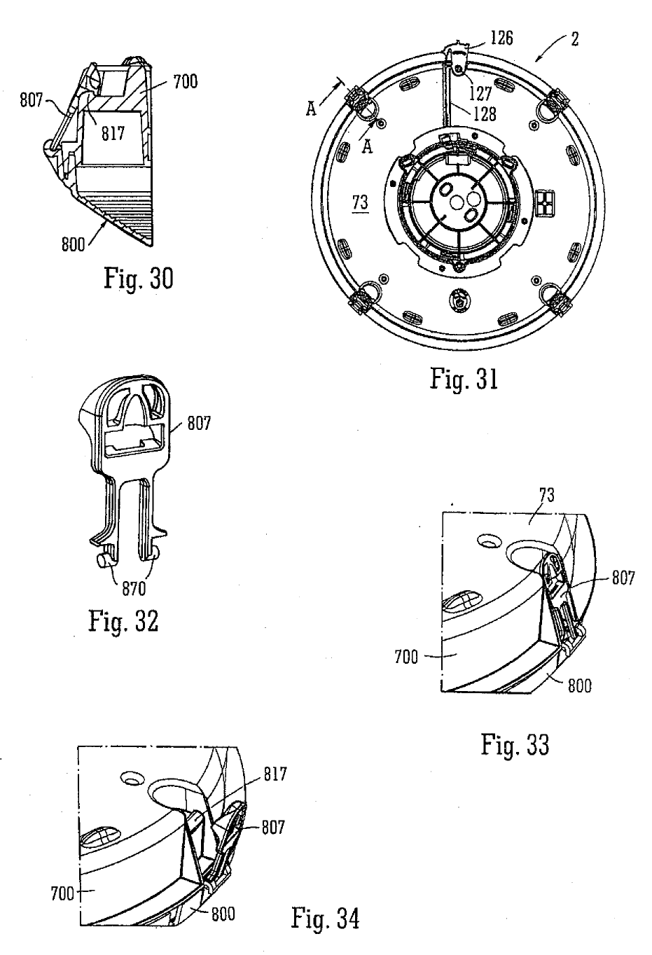

Referring now to FIGS. 30-34, these show details of the lamp unit of another embodiment of the invention. The lamp unit 2 is generally similar to that in FIGS. 21-24. A difference, however, is that the lamp unit comprises a removable diffuser or lens unit 800, which is releasably attached to a rear portion 700 of the lamp unit by means of a plurality of clips 807. Each clip comprises a pair of pins 870, arranged to pivot in pin-receiving means on the diffuser. The clips are arranged to engage corresponding ridges 817 on the rear portion. Thus, the clips 807 clip the diffuser and trim to the light fitting back. They compress the seal between the diffuser and back portion and are only accessible when the lamp unit is separated from the base unit (i.e. when the lamp unit has been removed from the wall or ceiling. They therefore provide a degree of tamper-resistance, yet facilitate bulb replacement (the bulb is accessible when the diffuser is unclipped from the back portion.

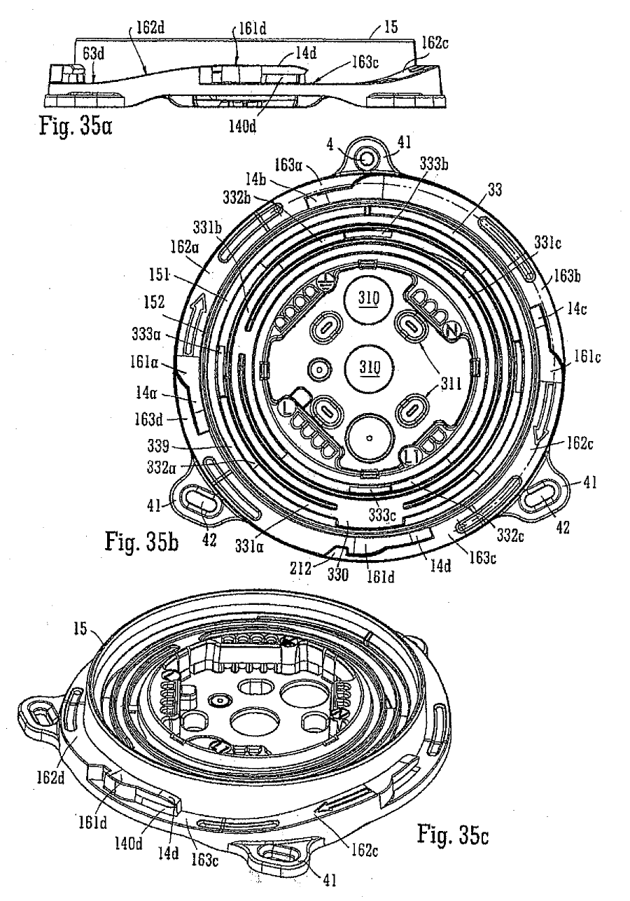

FIG. 35 (a), (b) and (c) are a side, plan and perspective view of a base unit of another lamp system in accordance with a second embodiment of the invention and corresponding to the embodiment illustrated in FIG. 2. The numeral notations in FIG. 35 correspond with those used in FIGS. 2 to 12 and the corresponding description of those Figures also applies to FIG. 35.

What is claimed is:

1. An electrical lamp system comprising:
a base unit for fixing to a wall or ceiling; and
a lamp unit for attachment to the base unit,
the base unit comprising a base housing, fixing means arranged for fixing the base housing to a wall or ceiling, a plurality of contact terminals secured at respective positions to the base housing and arranged to contact corresponding contact terminals of the lamp unit when attached, a plurality of connection terminals secured at respective positions to the base housing and adapted for connection to respective wires fed to the base unit, and connection means connecting the base unit contact terminals to the connection terminals such that wires suitably connected to the connection terminals can power the lamp unit via the base unit contact terminals,
the lamp unit comprising a lamp housing, at least one electrical lamp secured to the housing, a plurality of contact terminals secured at respective positions to the lamp housing and arranged to contact said contact terminals of the base unit, and connection means connecting the lamp unit contact terminals to the electrical lamp,
wherein the system further comprises:
attachment means arranged to attach the lamp unit to the base unit;
locating means arranged to locate the lamp unit in a first position against the base unit when the base unit is fixed to a wall or ceiling, the first position being a position in which the attachment means permits the lamp unit to be separated from the base unit by translation of the lamp unit in a direction away from the base unit along a separation axis; and
guide means arranged to permit and guide rotation of the lamp unit against the base unit about said axis from said first position to a second position, the second position being a position in which said contact terminals of the base unit are in electrical contact with said contact terminals of the lamp unit and in which the attachment means attaches the lamp unit to the base unit by preventing separation of the lamp unit from the base unit by translation of the lamp unit along said axis.

2. A lamp system in accordance with claim 1, the arrangement being such that when the base unit is fixed to a flat wall or ceiling using the fixing means, said separation axis is substantially perpendicular to the flat surface of the wall or ceiling.

3. A lamp system in accordance with any preceding claim, wherein the base housing is generally circular, centred on the separation axis.

4. A lamp system in accordance with any preceding claim, wherein the base housing comprises a generally cylindrical wall centred on said separation axis and extending along said axis, the locating means and the guide means comprising said wall.

5. A lamp system in accordance with claim 4, wherein the base housing further comprises a central portion, connected to and located radially inside said cylindrical wall, said base unit contact terminals and connection terminals being secured to the central portion.

6. A lamp system in accordance with claim 4 or claim 5, wherein the base housing further comprises an outer portion, connected to and located radially outside said cylindrical wall.

7. A lamp system in accordance with claim 6, wherein said outer portion comprises said fixing means.

8. A lamp system in accordance with claim 7, wherein said fixing means comprises a first radially extending lug provided with a fixing hole to permit a screw to pass through the hole to fix the lug to a wall or ceiling, and at least one further radially extending lug provided with a respective slot to permit a screw to pass through the slot into a wall or ceiling and permit a limited rotation of the base unit about said fixing hole before the screw through the respective slot is tightened.

9. A lamp system in accordance with any one of claims 6 to 8, wherein the lamp housing comprises a generally annular portion, adapted to locate over said cylindrical wall when the lamp unit is located in said first position, and a plurality of attachment members, each attachment member extending radially from the generally annular portion, said outer portion comprising a plurality of engagement surfaces, each engagement surface being arranged to engage a respective one of the attachment members when the lamp unit is located in the first position, said outer portion further comprising a plurality of captivating slots each arranged to receive at least a portion of a respective attachment member when the lamp unit is rotated from the first to the second position so as to inhibit translation of the lamp unit along the separation axis, and said outer portion further comprising a plurality of guide surfaces each arranged to contact and guide a respective attachment member from the respective engagement surface into the respective captivating slot as the lamp unit is rotated from the first to the second position.

10. A lamp system in accordance with claim 9, wherein each attachment member extends radially inwardly from the annular portion.

11. A lamp system in accordance with claim 9 or claim 10, wherein at least a portion of each said guide surface is ramped such that as the lamp unit is rotated from the first to the second position against the base unit the lamp unit also moves along the separation axis.

12. A lamp system in accordance with any preceding claim, further comprising locking means arranged to lock the lamp unit in said second position to prevent rotation of the lamp unit from said second position.

13. A lamp system in accordance with claim 12, wherein the locking means comprises a locking member resiliently mounted on the lamp unit and locking member receiving means provided on the base unit, the arrangement being such that as the lamp unit is rotated from the first to the second position the locking member is deflected and then springs into engagement with the receiving means to prevent rotation of the lamp unit from the second to the first position.

14. A lamp system in accordance with claim 12 or claim 13, as dependent upon any one of claims 9 to 11, wherein the locking means comprises a locking member resiliently attached to the annular member, and the outer portion comprises means for receiving the locking member when the lamp unit is in the second position.

15. A lamp system in accordance with claim 14, wherein the locking member is resiliently attached to one of said attachment members.

16. A lamp system in accordance with any one of claims 13 to 15, wherein the lamp unit further comprises means for disengaging the locking member from the receiving means so as to permit rotation of the lamp unit from the second to the first position.

17. A lamp system in accordance with claim 16, wherein the means for disengaging comprises means for pulling the locking member in a direction generally radially outwards.

18. A lamp system in accordance with claim 17, wherein the pulling means comprises a lever pivotally mounted to the lamp housing and a connecting member connecting the lever to the locking member.

19. A lamp system in accordance with claim 18, as dependent upon claim 9, wherein the lamp unit comprises an outer portion, attached to and located generally radially outside the annular portion, and said lever is pivotally mounted to the lamp unit outer portion.

20. A lamp system in accordance with claim 18 or claim 19, wherein the connecting member comprises a toothed portion, and the locking member comprises a slot adapted to receive and engage said toothed portion such that the connecting member can be pulled to deflect the locking member.

21. A lamp system in accordance with any preceding claim, wherein the base unit housing comprises at least one aperture for feeding a wire through the housing for connection to at least one of the connection terminals.

22. A lamp system in accordance with any preceding claim, wherein the base unit housing comprises at least one frangible portion removable to provide an aperture for feeding a wire through the housing for connection to at least one of the connection terminals.

23. A lamp system in accordance with any preceding claim, wherein the base housing is adapted to prevent touching of any of the base unit contact terminals and connection terminals with bare hands.

24. A lamp system in accordance with claim 23, wherein each base unit contact terminal is accessible to the respective lamp unit contact terminal through a respective access slot provided in the base housing.

25. A lamp system in accordance with claim 23 or claim 24, wherein each base unit connection terminal is accessible to a wire fed into the base unit through a respective access recess provided in the base housing.

26. A lamp system in accordance with any preceding claim, wherein each base unit contact terminal is sprung.

27. A lamp system in accordance with any preceding claim, wherein the base unit contact terminals comprise a live contact terminal, a neutral contact terminal, and an earth contact terminal, and the connection means is arranged to connect each of the live, neutral and earth contact terminals separately to a respective one of said connection terminals.

28. A lamp system in accordance with any preceding claim, wherein each connection terminal comprises a respective terminal block providing at least one wire receiving aperture for receiving a stripped wire end and wire clamping means for clamping the received stripped wire end in said receiving aperture.

29. A lamp system in accordance with claim 28, as dependent upon claim 27, wherein the plurality of connection terminals comprises:
a switch live terminal block connected to the live contact terminal and providing a wire receiving aperture and clamping means;
a neutral terminal block connected to the neutral contact terminal and providing at least two said wire receiving apertures and associated clamping means;
an earth terminal block connected to the earth contact terminal and providing at least three said wire receiving apertures and associated clamping means; and
a live terminal block providing at least three said wire receiving apertures and associated clamping means,
whereby the base unit may be connected as a junction box between two three-core cables and to a three-core switch cable.

30. A lamp system in accordance with claim 28 or claim 29, wherein each said wire receiving aperture and each corresponding clamping means is arranged in a respective recess provided in the base housing, each recess being configured to prevent touching of the respective terminal block or clamping means by a bare hand.

31. A lamp system in accordance with any preceding claim, wherein each lamp unit contact terminal comprises a respective pin.

32. A lamp system in accordance with claim 31, wherein each pin has a longitudinal axis generally parallel to the separation axis.

33. A lamp system in accordance with claim 32, wherein each pin is arranged such that its longitudinal axis is radially spaced from the separation axis, such that as the lamp unit is rotated from the first to the second position each pin travels through a respective arc.

34. A lamp system in accordance with claim 33, wherein said pin axes are differently spaced from the separation axis, such that each said arc has a different respective radius.

35. A lamp system in accordance with claim 33 or claim 34, wherein the base unit comprises a plurality of arcuate pin-receiving slots, each arranged to axially receive a respective one of said pins and to permit the received pin then to travel along its respective arc as the lamp unit is rotated to bring the pin into contact with the respective base unit contact terminal.

36. A lamp system in accordance with claim 35, wherein the lamp unit comprises a plurality of guide members, each guide member being arranged adjacent a respective one of said pins, the base unit comprising a plurality of arcuate guide surfaces, each arcuate guide surface being arranged to contact a respective one of said guide members when the lamp unit is in the first position and to guide the guide member along a respective arcuate path as the lamp unit is rotated from the first position towards the second position to bring the respective pin into its respective pin-receiving slot and then into engagement with its respective base unit contact member.

37. A lamp system in accordance with claim 36 wherein at least a portion of each arcuate guide surface is ramped.

38. A lamp system in accordance with claim 36 or claim 37, wherein each guide member extends axially at least to the end of its respective pin.

39. A lamp system in accordance with any one of claims 36 to 38, wherein each guide member is arranged radially outside its respective pin.

40. A lamp system in accordance with any one of claims 36 to 39, wherein the base housing comprises a base portion and a cover portion attached to the base potion, said base unit contact terminals and connection terminals being secured to the base portion, and the cover portion comprising said arcuate pin-receiving slots and arcuate guide surfaces.

41. A lamp system substantially as hereinbefore described with reference to the accompanying drawings.

42. A lamp system base unit substantially as hereinbefore described with reference to the accompanying drawings.

43. A lamp system luminaire substantially as hereinbefore described with reference to the accompanying drawings.
